(19) United States
(12) Patent Application Publication
(10) Pub. No.: US 2022/0214249 A1
(43) Pub. Date: Jul. 7, 2022

(54) Device for dicing biological tissue into fragments

(71) Applicant: The Board of Trustees of the Leland Stanford Junior University Office of the General Counsel, Bldg, Stanford, CA (US)

(72) Inventors: Sindy K. Y. Tang, Stanford, CA (US); Nicolas Castaño, Stanford, CA (US); Saisneha Koppaka, Stanford, CA (US); Seth Xordts, Stanford, CA (US)

(21) Appl. No.: 17/569,775

(22) Filed: Jan. 6, 2022

Related U.S. Application Data
(60) Provisional application No. 63/134,559, filed on Jan. 6, 2021.

(51) Int. Cl. G01N 1/28

(52) U.S. Cl. CPC G01N 1/286; G01N 2001/2873

(57) ABSTRACT

A microscale biological tissue cutting device is made of a horizontal array of identically shaped polygonal through holes between vertically-oriented blades which form the sides of the polygonal through holes. Each of the through holes has a width less than 1 mm. The blades are joined at vertices of the polygonal through holes and have vertical peaks at the vertices. The vertical peaks have heights in the range 1-200 μm above a lowest height of a cutting edge of the blades. The blades may be made of a material such as silicon, glass, plastic, resin, or metal.

### CROSS-REFERENCE TO RELATED APPLICATIONS

This application claims priority from U.S. Provisional Patent Application 63/134,559 filed Jan. 6, 2021, which is incorporated herein by reference.

### STATEMENT OF FEDERALLY SPONSORED RESEARCH

This invention was made with Government support under contracts 1548297 and 1938109 awarded by the National Science Foundation. The Government has certain rights in the invention.

### FIELD OF THE INVENTION

The present invention relates generally to techniques for mincing or dicing tissue. More specifically, it relates to devices and methods for dicing tissue into uniform micro-scale pieces.

### BACKGROUND OF THE INVENTION

The ability to generate small and uniform fragments from tissues is important for disease diagnostics (e.g., histology), drug screening (e.g., personalized cancer medicine), fundamental studies mapping the spatial distribution of different molecules and cell types within the tissues (e.g., spatial-omics) and their interactions with the tissue microenvironment, and even wound repair and regeneration studies. Common mechanical dissection methods, such as manual mincing with scissors or scalpels, as shown in FIG. 1A, are imprecise and result in tissue fragments with non-uniform sizes, which can lead to undesirable variability in subsequent analyses. In addition, the manual method is slow, labor-intensive and introduces contamination risk. There exist tissue grinders or homogenizers that pass the tissue through a mesh filter and/or shear the tissue with a rotating blade. The resulting fragments, however, still have a broad size distribution. Laser capture microdissection (LCM) is by far the most precise tool for extracting cell clusters from a tissue slice. However, LCM requires the samples to be prepared in very thin slices. Moreover, because LCM is a serial process, the isolation of many fragments is slow. These limitations of existing methods demonstrate a need for a fast and efficient way to cut tissues into microfragments of controllable and uniform size.

### SUMMARY OF THE INVENTION

In one aspect, the invention provides a microscale dicing device, referred to as the μDicer, that can cut biological tissues into multiple uniformly sized sub-millimeter fragments in a parallel manner. The μDicer is composed of a hollow array of blades spaced hundreds of micrometers apart. A tissue pushed through this array is diced into many microfragments simultaneously. The blades of the μDicer may be composed of silicon and fabricated using a combination of isotropic and anisotropic etching. A single silicon oxide etch mask is used in a dry silicon etcher for both a tapered etch to form the microblades, and an anisotropic etch to form the through-holes in the hollow blade array. The use of a single mask for both etching at an angle and straight down reduces the mask fabrication time by more than twofold compared with two-mask approaches often used to generate similar etch features. The etch parameters and the design of the etch mask control the blade angles and the edge profiles of the blades. The incorporation of “notches” in the two-dimensional mask design may be used to generate three-dimensional microserrated features on the blade edges.

As an alternative to silicon, the μDicer may be fabricated from other materials such as glass, plastic, resin, or metal. Applications of the μDicer include drug screening on tissue biopsy samples, generating fragments for tissue culture studies, dicing tissue for spatial-omic studies of molecules, cell distributions within tissues, and location-specific gene expression, and dicing soft materials of any kind into uniform fragments.

In one aspect, the invention provides a microscale tissue cutting device comprising a horizontal array of identically shaped polygonal through holes between vertically-oriented blades forming the sides of the polygonal through holes and joined at vertices of the polygonal through holes, wherein each of the identically shaped polygonal through holes has a width less than 1 mm, wherein the vertically-oriented blades have vertical peaks at the vertices of the polygonal through holes, where the vertical peaks have heights in the range 1-200 μm above a lowest height of a cutting edge of the blades, and wherein the vertically-oriented blades are made of a material selected from the group consisting of silicon, glass, plastic, resin, and metal.

Preferably, the vertically-oriented blades are serrated with one, two, or more serrations forming secondary vertical peaks. Preferably, the secondary vertical peaks have heights in the range 1-100 μm above the lowest height of the cutting edge of the blades. Preferably, the vertical peaks have an interior angle of 5-120 degrees in a vertical cross-sectional plane parallel to the blade. Preferably, the secondary vertical peaks have an interior angle of 5-120 degrees in a vertical cross-sectional plane parallel to the blade.

Preferably, the cutting edge of the vertically-oriented blades has a bevel angle in the range 5-90 degrees in a vertical cross-sectional plane perpendicular to the blade. Preferably, the cutting edge of the vertically-oriented blades has a tip radius of curvature in the range 1 nm-1 μm.

Each of the identically shaped polygonal through holes may have a shape selected from the group consisting of a square, a rectangle, or a hexagon. The horizontal array of identically shaped polygonal through holes may be a one-dimensional array or a two-dimensional array.

### BRIEF DESCRIPTION OF THE DRAWINGS

FIG. 1A is a schematic diagram illustrating mechanical dissection by manual mincing using a scalpel, as is known in the art.

FIG. 1B is a schematic diagram of a microscale dicer having a two-dimensional array of blades forming sub-mm wide through holes, according to an embodiment of the invention.

FIG. 1C is a process flow diagram illustrating a method for fabricating a microscale dicer in silicon, according to an embodiment of the invention.

FIG. 2A is a diagram illustrating the geometrical parameters of various blade geometries, according to an embodiment of the invention.

FIG. 2B is a table showing various design parameters used for example microscale dicing devices, according to an embodiment of the invention.

FIG. 3A is a schematic diagram illustrating three mask designs for microscale dicers with 0, 1, and 2 serrations, according to an embodiment of the invention.

FIG. 3B is a diagram showing the time evolution of the etch process showing how a serration in a blade is formed, according to an embodiment of the invention.

FIG. 3C shows scanning electron microscope (SEM) images of microscale dicers fabricated with zero, one, and two serrations, according to an embodiment of the invention.

FIG. 3D shows geometrical details and dimensions for various etch mask designs showing blades with different numbers of serrations, according to an embodiment of the invention.

FIG. 4A shows images depicting the progression of the etching process for a mask with a single notch that generates blades with one serration, according to an embodiment of the invention.

FIG. 4B, 4C, 4D show simulation results for three mask designs producing blades with zero, one, and two serrations, respectively, according to an embodiment of the invention.

FIGS. 5A, 5B, 5C compare the uniformity of the fragments cut using the μDicer (right) vs. manual mincing (left) for agar, porcine cartilage, and porcine liver, respectively.

FIG. 5D shows boxplots of fragment widths generated by manual mincing vs. μDicers, according to an embodiment of the invention.

FIG. 5E is a schematic diagram showing the modification of a 3 mL-syringe for dicing tissue samples, according to an embodiment of the invention.

FIGS. 6A, 6B show two views of a dicer having hexagonal shaped through holes, according to an embodiment of the invention.

FIG. 7 is an image of a μDicer fabricated with a one-dimensional array of long rectangular through holes to generate slices of tissue, according to an embodiment of the invention.

### DETAILED DESCRIPTION OF THE INVENTION

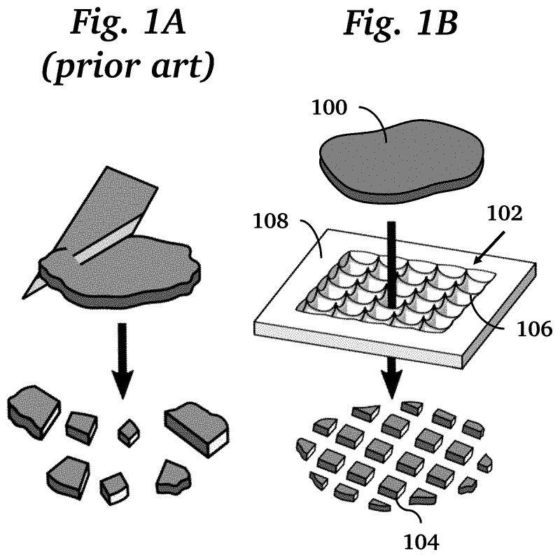

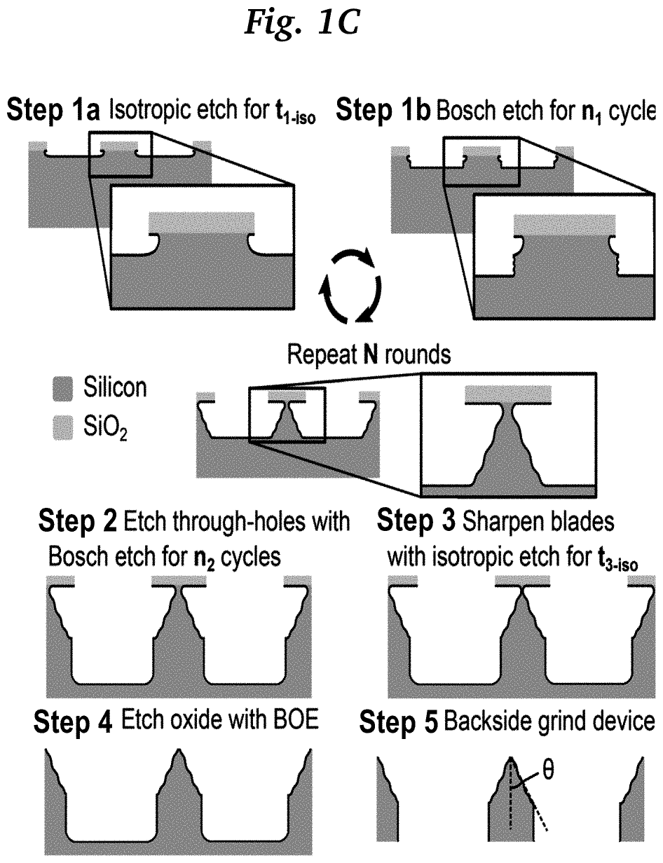

In one embodiment of the invention, a μDicer is a hollow array 102 of blades 106 that are spaced hundreds of micrometers apart, as shown in FIG. 1B. When a tissue 100 is pushed through this array 102, it is diced by the blades 106 into many microfragments 104 simultaneously. More specifically, the microscale tissue cutting device comprising a horizontal array 102 of identically shaped polygonal through holes between vertically-oriented blades 106 forming the sides of the polygonal through holes and joined at vertices of the polygonal through holes. As will be described in more detail below, the vertically-oriented blades have vertical peaks at the vertices of the polygonal through holes, and may have serrated edges. The vertically-oriented blades are made of a material such as silicon, glass, plastic, resin, and metal. The array of blades is surrounded by a frame 108 made of the same material as the blades. The vertical orientation of the blades is defined here to mean that the plane of the blades are oriented perpendicular to the plane of the array, which is defined as the horizontal direction.

A silicon μDicer may be fabricated using a microfabrication method that uses a combination of isotropic and anisotropic etching in a dry plasma etcher. This method of fabrication of a hollow array of sharp blades with microserrations in silicon advantageously uses a single lithographic and etch mask for two etch processes (i.e., tapered etch and through-hole etch). The use of a single mask reduces the mask fabrication time since the wafer does not require stripping and re-patterning. The etch parameters control the blade angles, whereas the notches on the etch mask control the microserrations along the blade.

FIG. 1C shows the process flow for etching the blades and through-holes in silicon, according to an embodiment of the invention. We fabricated the μDicer out of a 4″ single-side polished silicon <110> wafer. After growing a top oxide layer (3 mm) by chemical vapor deposition (PlasmaTherm, Shuttlecock SLR-750 PECVD), the silicon oxide layer was primed with hexamethyldisilane to improve photoresist adhesion to the oxide layer (YES HMDS vapor prime oven). Then, photoresist SPR3612 (1.6 mm) was coated onto the wafer using a Silicon Valley Group (SVG) developer instrument (Model 8638 VP). The photoresist mask was patterned by standard lithography (Heidelberg MLA150 direct write lithography tool) with a −2 μm defocus and 85 mJ/cm² dose and then developed and post-exposure baked with an SVG developer instrument (Model 8632 CTD/8636 HP). The wafer was descummed using a Technics Plasma Asher. The photoresist mask was used to etch the oxide layer for ˜30 min with a 6:1 buffered oxide etchant (BOE) (34% Ammonium fluoride, 7% Hydrofluoric acid, 59% water). After the oxide etch, the photoresist mask was stripped from the wafer with Piranha (70%-90% sulfuric acid, hydrogen peroxide) for ˜10 minutes at 120° C., followed by 6 cycles of rinses in deionized (DI) water. This process produced the wafer leading up to Step 1a of FIG. 1C.

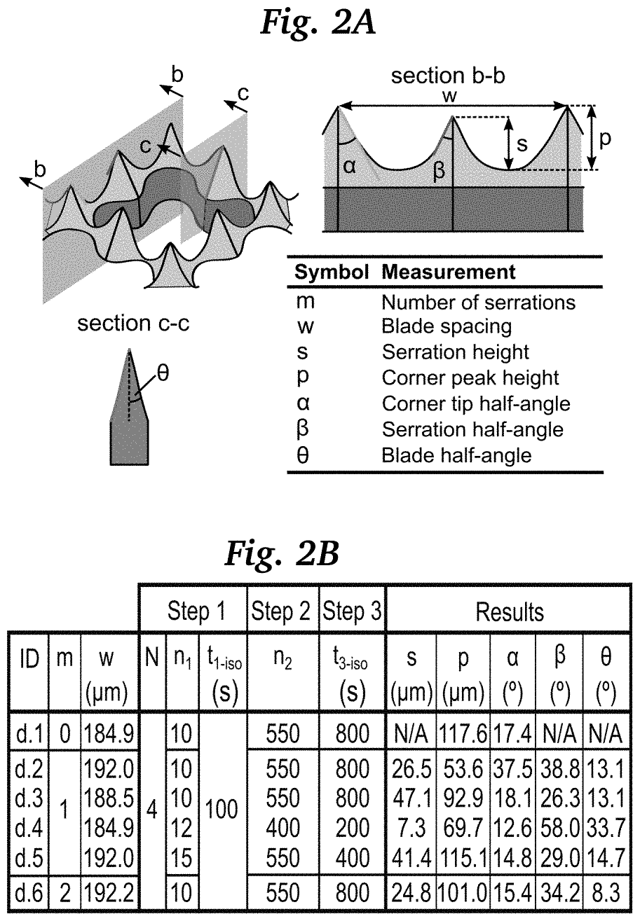

As illustrated in FIG. 1C, to form an array of microblades in silicon (step 1), we used a single etch mask composed of silicon dioxide and performed tapered etches by cycling between isotropic etches (for t1-iso seconds) and deep reactive-ion etches (DRIE) using a Bosch process (for n1 cycles). This process was repeated N rounds in an inductively coupled plasma deep silicon etcher (PlasmaTherm, Versaline). The values of n1 and t1-iso were chosen to control the angle of the overall etch and, thus, the half-angle of the blade θ. In general, θ is expected to decrease with the increasing ratio of anisotropic etch to isotropic etch. Experimentally, it has been shown that increasing n1 relative to t1-iso decreased θ, everything else held constant. Since the detailed examination was described previously, we did not repeat the characterization here. For the etch conditions tested, θ varied from approximately 8° to 34° (see FIG. 2B). Here, θ did not decrease monotonically with the increasing ratio of n1 to t1-iso since we did not fix other variables, including the geometry of the mask, which changed the local etch rates in both the isotropic and anisotropic etches. The number of rounds (N) controlled the point at which the etch fronts undercutting the oxide mask met to form the blades. We chose N ¼ 4 so that the etch stopped immediately before the etch fronts met. N>4 resulted in over-etching and instability of the mask.

In step 2, we used the Bosch process (n2 cycles) to etch the through-holes most of the way through the wafer (˜350 μm). The depth of the etch was measured with digital microscopy at intermittent points. Additional Bosch cycles (in batches of 50) were performed until the remaining wafer thickness was ˜50 μm. In the through-hole etch in Step 2, the bias voltages (250 V for 200 cycles, then 350 V for 200 cycles) were chosen to produce a clean deep etch. We found that bias voltages lower than 250 V led to an increased degree of grassing and rough surfaces.

In step 3, we sharpened the blades with an isotropic etch (t3-iso). The value of t3-iso was determined by monitoring the progression of the etch fronts every 100 s until the corner tips formed. After completing the etches, we removed the top oxide mask and ground the backside of the wafer until the through-holes were fully exposed. We chose to perform backside grinding instead of etching the wafer all the way because the latter resulted in unavoidable narrowing of the bottom of the through-hole, which would hinder the passing of the diced tissue.

After completing the etches (Steps 1-3), the wafer was sonicated in a 6:1 Buffered Oxide Etch (BOE) for 5 minutes to remove the top oxide mask (Step 4). Finally, in Step 5, we used an automatic surface grinder (DISCO, DAG810) to grind the backside of the wafer until the through-holes were fully exposed (˜50 μm ground). The blades were coated in polishing pitch #750 (Universal Photonics Inc.) and mounted to a carrier wafer topside facing down prior to grinding. We had chosen to perform this backside grinding instead of etching the wafer all the way because the latter resulted in unavoidable tapering and narrowing of the bottom of the through-hole, which would hinder the passing of the diced tissue.

Etch parameters and further fabrication details are listed Table 1.

TABLE 1
Etch parameters used for silicon μDicer.

| | | | | | Through- | |
|---|---|---|---|---|---|---|
| | | | | | hole | |
| | | | | | etch | |
| | | | | | (Step 2) | |
| | | | | | Anisotropic | |
| | | | | | etch | |
| | Blade tapered etch (Step 1) | | | | (Bosch | |
| | Bosch recipe | | | | process) | Blade |
| | | Aniso- | | | 0.9 μm/ | sharpening |
| | | tropic | Iso- | Iso- | cycle | (Step 3) |
| | Aniso- | passi- | tropic | tropic | (6.35 | Isotropic |
| | tropic etch | vation | etch | etch | μm/min) | etch |
| Time (s) | 1.5 | 2.5 | 3 | 100 | Same as | 200-800 |
| Pressure | 40 | 25 | 75 | 25 | tapered | 25 |
| (mT) | | | | | etch | |
| C₄F₈ | 150 | 150 | 0 | 50 | Bosch | 50 |
| (sccm) | | | | | recipe | |
| SF₆ (sccm) | 150 | 150 | 300 | 300 | | 300 |
| Ar (sccm) | 30 | 30 | 30 | 30 | | 30 |
| Bias | 250 | 10 | 10 | 10 | 200 cycles at | 10 |
| voltage | | | | | 250 V, then | |
| (V) | | | | | 200 cycles | |
| | | | | | at 350 V | |
| ICP | 2000 | 2000 | 3000 | 3000 | Same as | 3000 |
| power | | | | | tapered etch | |
| (W) | | | | | Bosch recipe | |

FIGS. 2A-B show, respectively, a diagram defining the blade geometries and a table showing the corresponding mean measured values and device identifiers for example devices. The parameters shown for these example devices are illustrations only. More generally, the vertically-oriented blades may be serrated with zero, one or two serrations forming secondary vertical peaks. The secondary vertical peaks preferably have heights in the range 1-100 μm above the lowest height of the cutting edge of the blades. The vertical peaks preferably have an interior angle of 5-120 degrees in a vertical cross-sectional plane parallel to the blade. The secondary vertical peaks preferably have an interior angle of 5-120 degrees in a vertical cross-sectional plane parallel to the blade. The cutting edge of the vertically-oriented blades preferably has a bevel angle in the range 5-90 degrees in a vertical cross-sectional plane perpendicular to the blade. The cutting edge of the vertically-oriented blades preferably has a tip radius of curvature in the range 1 nm-1 μm.

The single-mask fabrication method described above has two advantages. First, it reduced the mask fabrication time by more than two times compared with a two-mask approach. In our facilities, the mask fabrication process for a single wafer took ˜3 h. For a two-mask approach, this process would, thus, take at least 6 h, not accounting for additional time spent coating protective layers onto previously etched features. Second, the single-mask approach eliminated the need for mask alignment. Nevertheless, we recognize the trade-off in using a single etch mask, namely the limited control of the shape of the through-holes because the shape of the blades and through-holes were both determined by the same mask. Finally, we note that although it was possible to generate blades using isotropic etches only (in step 1), the blades were not sufficiently sharp, with θ˜50°, so this method is not preferred.

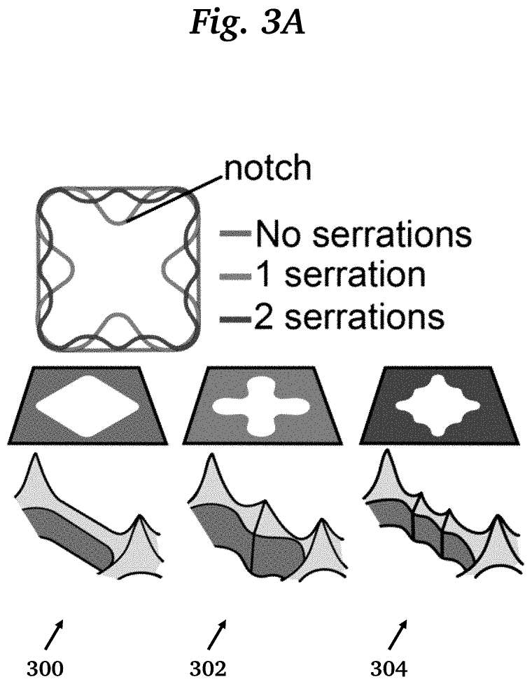

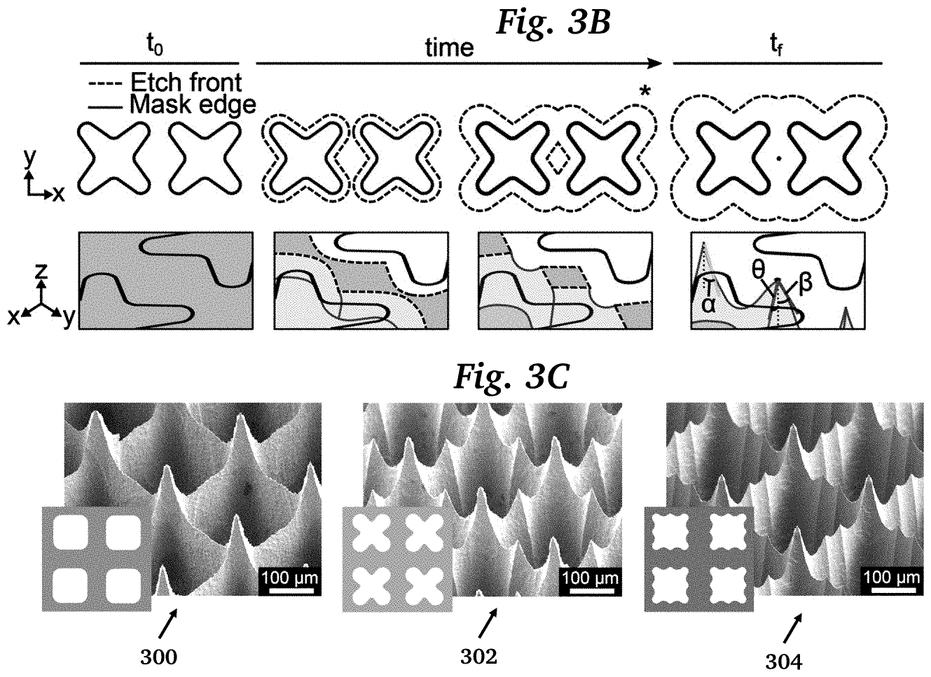

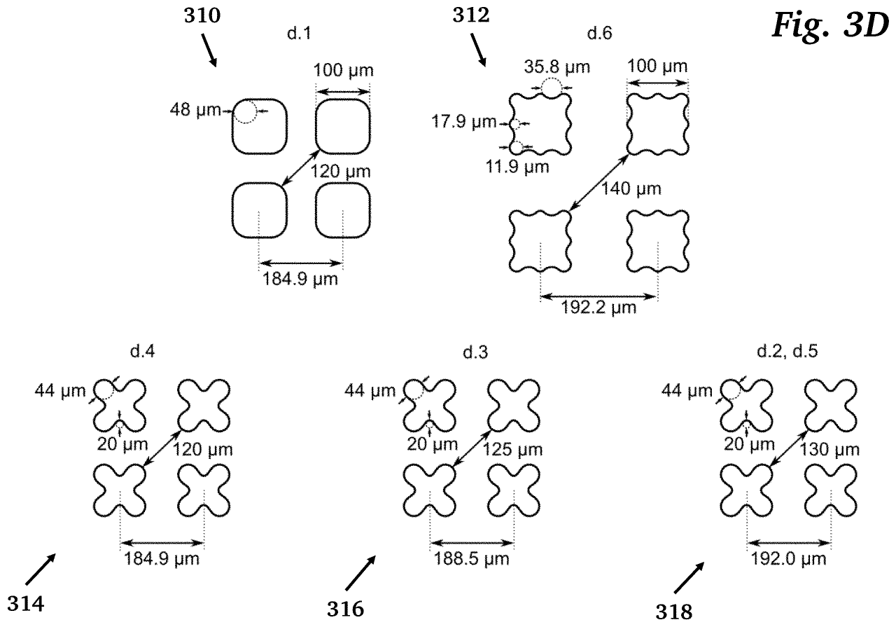

FIGS. 3A-C show the effect of the shape of the etch mask on the formation of microserrations on the blade edges. Although the serrations were 3D features, a 2D etch mask design with notches was sufficient to create these serrations. FIG. 3A shows three mask designs 300, 302, 304 for μDicers with 0, 1, and 2 serrations, respectively, together with the corresponding serration geometries. Only a single cell of the entire array is shown. FIG. 3D shows additional details and dimensions for etch mask designs for fabricating the μDicers having blades with 310 zero serrations, 312 two serrations, 314 one serration, 316 one serration, and 318 one serration.

The notches on the etch mask increased the distance between the two undercutting etch fronts from the neighboring cells and controlled the point at which the two etch fronts intersected. FIG. 3B is a diagram showing the time evolution of the etch process showing how a serration is formed during steps 1 and 3 of the process flow. (Step 2 was excluded as it does not affect blade formation.) For simplicity, only two cells are shown. The asterisk indicates the expected profile at the end of step 1. As the etch proceeded, the two etch fronts intersected to result in a diamond-shaped plateau and eventually a tip at t_{f} at the end of step 3 forming a serration on the blade edge. Here, t_{f} corresponds to the combined isotropic etching time. FIG. 3C shows SEM images of μDicers 300, 302, 304 with zero, one, and two serrations, respectively, and the corresponding etch masks. As can be seen, the number of notches in the mask corresponds to the number of serrations in the blade.

FIGS. 2A-B show the measured number of serrations, serration heights, and blade angles for different example etch mask designs and etch parameters used. This includes measurements of angles α and β, the angles of the corner, and serration tips that are coplanar with the blade edge, respectively. They were controlled by the tapered etch (step 1), the mask design, and the isotropic etch (step 3) when the etch fronts from neighboring cells intersected under the oxide mask (also see profile at t_{f} in FIG. 3B). They are, thus, different from θ, which is orthogonal to the plane of the blade edge, in that θ depended primarily on the tapered etch. β scaled roughly with θ, but the trend in a was difficult to predict due to the non-trivial interactions of the etch fronts.

The following general design guidelines were observed to maintain the stability of the oxide mask which is undercut to form the blades:
The corners of any mask opening should be rounded. Without rounding, stress concentrations at sharp corners would cause the mask to crack during the etching process. We found that our designs with corner radius of curvature r of more than 5 μm had significant reduction in mask failure. While we did not identify the minimum radius needed, we expect that larger mask openings require larger values of r.
The strut dimensions are also critical as this part of the mask is eventually completely undercut and unsupported in the middle. The ratio of the strut's shortest dimension (l) to longest dimension (h) should be more than ˜0.5. We did not test this ratio extensively but noticed a l:h ratio less than 0.5 led to mask cracking when undercutting the mask to form the blades.

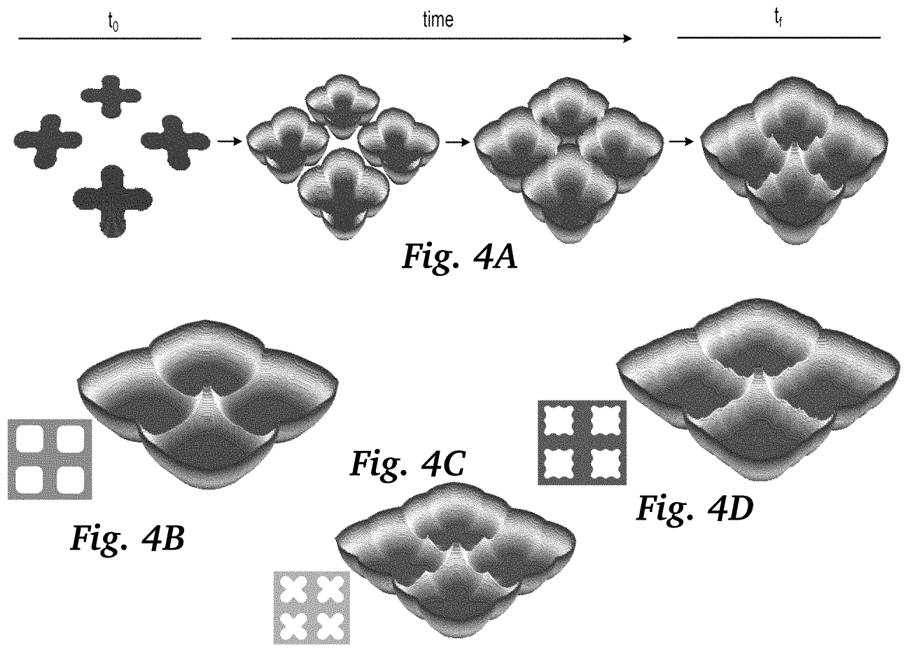

While the notches in the etch mask were able to generate 3D serrations, as expected, the resulting etch profiles were not always easy to predict. As such, we developed a custom model to simulate steps 1 and 3 of the etching process. The goal of this model was to provide a computationally inexpensive, qualitative prediction of the shape of the etched blade geometry, rather than to match the exact etch profile quantitatively. This simulation can, thus, inform design decisions before fabrication. Briefly, the simulation implements a sparse field level set approach to model the etch fronts. The inputs to the model included the mask design file, the recipe steps, the known horizontal and vertical etch rates, and the desired resolution. The outputs of the model were isometric images of the etch profile produced every two time steps, and an interactive visualization (in .vtk format) of the final 3D model. By allowing open access to this code, we aim to make our model accessible for use and adaptation. The current version evolves the etch front using known etch rates, but the framework is in place to adapt the model to implement more complex etching physics (e.g., ray tracing, ion-surface chemistry, and other surface kinetics). The etch rates for our model were determined experimentally by performing an isotropic etch test on a patterned wafer and measuring the vertical and horizontal etch distances for a given etch time. Our model is adaptable for different combinations of isotropic and Bosch etches and can be applied to other plasma etchers with known etch rates. As shown in FIGS. 4B-D, the model generated etch profiles that matched the experimental etch profiles qualitatively, reproducing the correct number of serrations.

FIG. 4A shows images depicting the progression of the etching process in steps 1 and 3 of the process flow simulated by our model for a mask with a single notch that generates a μDicer with one serration. Only four cells are modeled. FIG. 4B-D show simulation results (for steps 1 and 3 of the process flow) for three mask designs included in the inset.

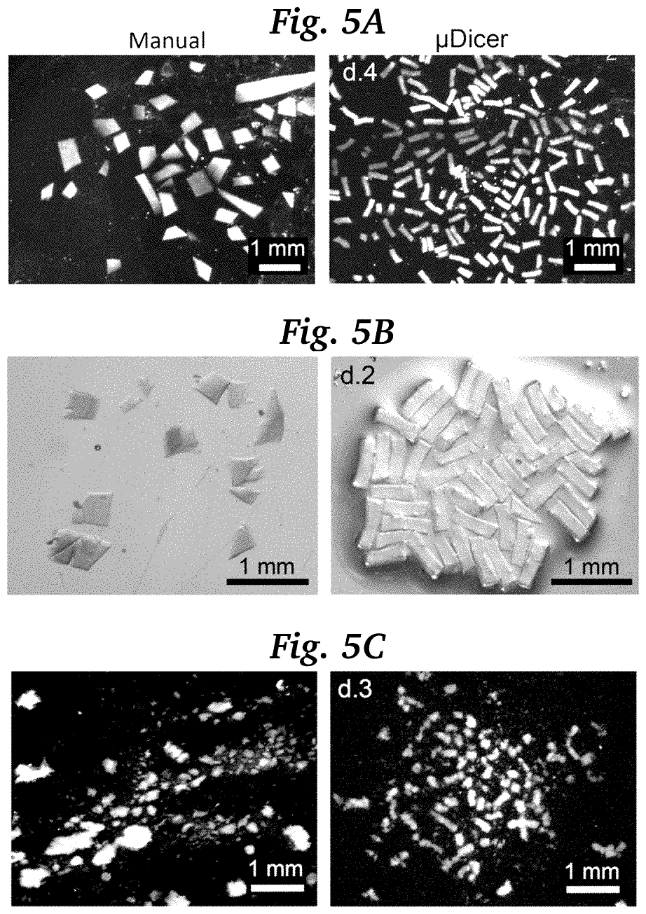

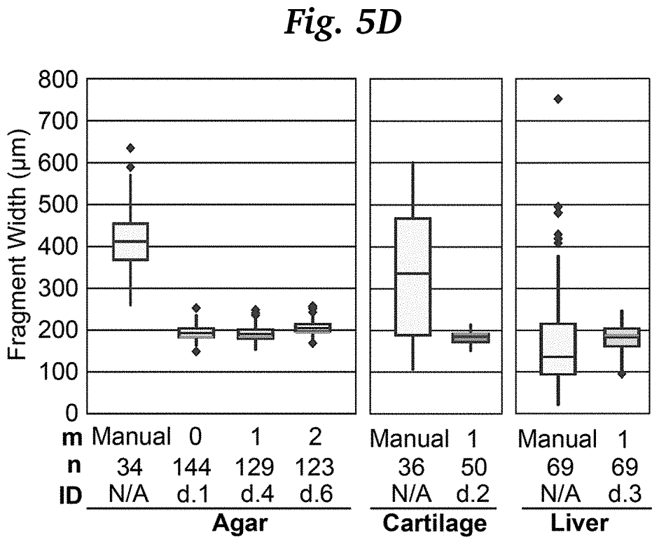

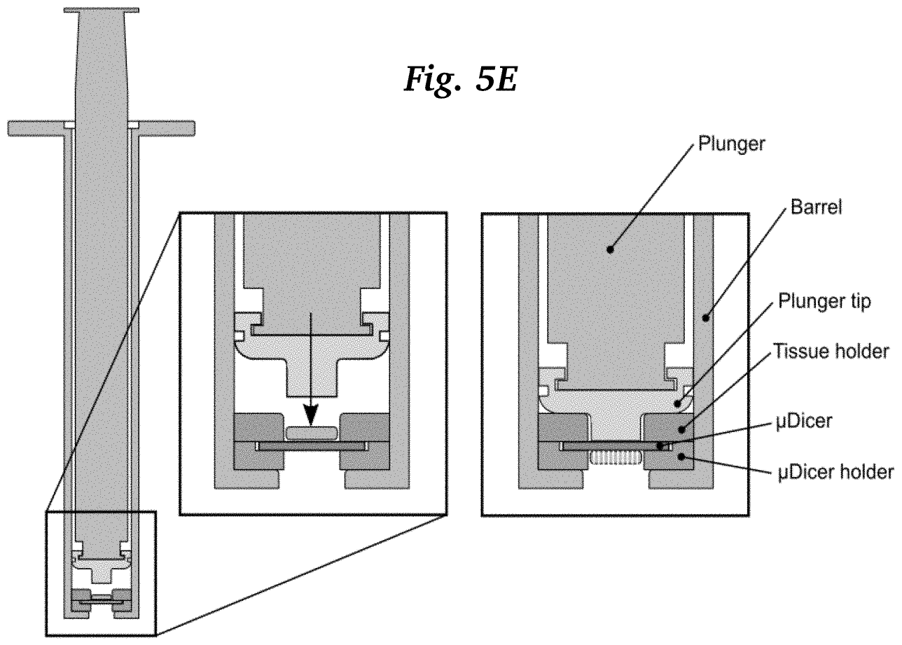

As a proof of concept of its utility, we used the silicon μDicer to cut agar (5% w/v), porcine articular cartilage, and porcine liver with approximate stiffnesses of 22.5 kPa, 2.6 MPa, and 1.1 kPa, respectively. All samples (˜2-3 mm in diameter and 0.2-1 mm in thickness) were pressed and extruded through the μDicer (total blade array area ˜3×3 mm²) with a rubber tipped plunger. FIG. 5E is a schematic diagram showing the modification of a 3 mL-syringe for dicing tissue samples. A custom flat plunger tip made of poly(dimethylsiloxane) was cast from a 3D-printed mold. A 3D-printed μDicer holder was made to fit inside the syringe and to hold the μDicer. The sample (agar or tissue) was placed with tweezers into the 3D-printed tissue holder above the μDicer. The syringe plunger was then pressed and lowered to push the tissue through the μDicer. Subsequently, the plunger was removed, and phosphate buffered saline (PBS) was added to the syringe. The plunger was re-inserted to push the PBS through the μDicer to dislodge remaining fragments. The narrow tip of the syringe was cut off to allow the fragments to pass through without obstruction. The fragments were collected from the opposite side of the μDicer into a Petri dish and imaged to measure the dimensions of the fragments.

FIGS. 5A-C show the uniformity of the fragments cut using the μDicer (right) vs. manual mincing (left) for agar, porcine cartilage, and porcine liver, respectively. The median fragment size generated by different μDicers ranged from 187 to 206 μm, within 6.6% from the blade spacing of the respective μDicers used. In comparison, it was difficult to control the median fragment size using manual mincing. The maximum interquartile range (IQR) of fragments generated using μDicers was 43 μm (or 24% of the median) for the liver sample, whereas manual mincing had an IQR up to 127 μm (or 92.4% of the median) for the cartilage sample.

FIG. 5D shows boxplots of fragment widths generated by manual mincing vs μDicers with different number of serrations (m) and device IDs as labeled. The fragment width was determined by measuring the narrowest dimension passing through the centroid of the fragment in ImageJ. The box represents the interquartile range (IQR). The upper whisker is the largest dataset value smaller than 1.5×IQR above the third quartile, and the lower whisker is the smallest dataset value larger than 1.5×IQR below the first quartile. Black dots represent outliers. The horizontal black line indicates the median. The horizontal red line indicates the blade spacing (w) for the device used to cut that sample. Sample size (n) are included at the bottom of the plots. Fragments smaller than ˜20 μm were excluded here.

The agar and tissue fragments cut by the μDicers were uniform and matched the blade spacing of the μDicers. While the example silicon device uses a blade spacing of ˜200 μm, our fabrication process may be used to generate blade spacing as small as ˜15 μm (from a 500 μm-thick silicon wafer), as limited by the plasma etching, which becomes challenging to create features with aspect ratios exceeding 30:1.39 The serrations made no significant difference in the fragment uniformity (tested in agar only), but are expected to change the cutting force.

The μDicers may be integrated with automated sample loading and extrusion and the detailed characterization of the cutting process and its dependence on the blade geometries. In addition to dicing agar, cartilage, and dead tissue, the μDicer can dice thawed tissue (from frozen), fresh tissue, Formalin fixed paraffin embedded (FFPE) tissue, and ethanol or methanol fixed tissue.

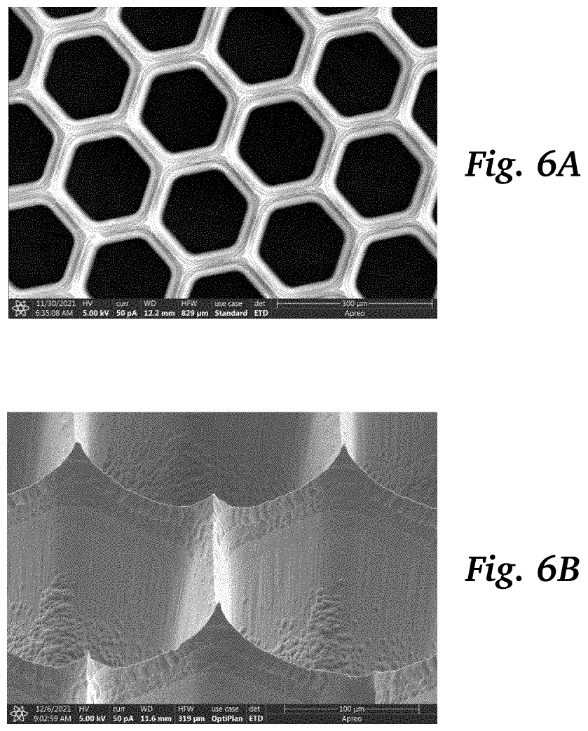

Although the through holes in the dicer described above has a square shape, other shapes may be used such as a rectangle, a hexagon, or other polygon. For example, FIGS. 6A-B show two views of a dicer with hexagonal through holes. For two-dimensional arrays of regular polygons, the cross-sectional width of the polygon in every direction is preferably less than 1 mm. In the case of a one-dimensional array of polygons such as rectangles where width and length may be distinguished, although the maximum width is less than 1 mm, the length may be more than 1 mm. In general, the smallest cross-sectional width of the through hole is less than 1 mm.

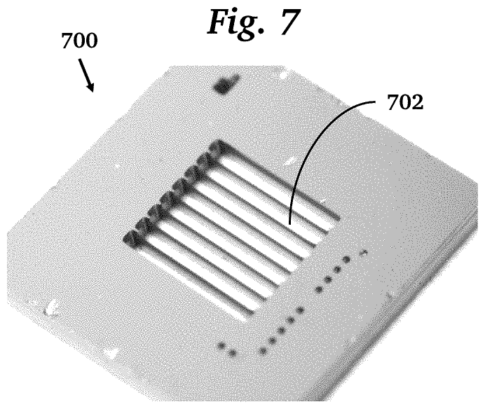

In an alternate embodiment, horizontal array of identically shaped polygonal through holes may be a one-dimensional array or a two-dimensional array. For example, in one embodiment, the μDicer 700 is designed with a one-dimensional array of long rectangular through holes between blades 702 to generate slices of tissue, as illustrated in FIG. 7. The rectangular through holes have a maximum width less than 1 mm, although their length may be more than 1 mm.

To sharpen the vertically-oriented blades, oxidation sharpening may be preferable in some embodiments. Oxidation sharpening may be performed after removal of the top oxide mask (Step 4). Thermally grown oxide may be stripped with hydrogen fluoride to reduce tip radius of curvature.

To improve toughness and resistance to fracture of silicon dicers, in some embodiments it is preferable to coat the silicon devices with silicon carbide (SiC) using plasma enhanced chemical vapor deposition. Compared to bare silicon devices, the SiC-coated devices withstand a larger amount of force before breaking. Alternatively, the silicon devices may be coated with other materials, such as silicon nitride, or with metals such as platinum deposited through sputtering.

In other embodiments, the μDicer may be fabricated using alternative materials, such as glass, plastic, resin, and metal. For fabrication of the μDicer in fused silica glass, a combination of hydrogen fluoride and laser-induced deep etching technology may be used to etch the blades and open through-holes of the μDicer. For fabrication in resin, high resolution 3D printers, such as those that utilize two-photon polymerization or stereolithography, may be used to print the μDicer. A computer-aided-design file in the preferred file format is used as an input for 3D printing. Alternatively, a master mold may be made, possibly by 3D printing, to cast the device out of resin. Alternatively, for fabrication with plastic filament, extrusion 3D printers may be used or the plastic may be cast in a master mold. For possible fabrication of the μDicer in metal, state-of-the-art metal 3D printers may be used.

1. A microscale tissue cutting device comprising a horizontal array of identically shaped polygonal through holes between vertically-oriented blades forming the sides of the polygonal through holes and joined at vertices of the polygonal through holes,
wherein each of the identically shaped polygonal through holes has a width less than 1 mm,
wherein the vertically-oriented blades have vertical peaks at the vertices of the polygonal through holes, where the vertical peaks have heights in the range 1-200 μm above a lowest height of a cutting edge of the blades, and
wherein the vertically-oriented blades are made of a material selected from the group consisting of silicon, glass, plastic, resin, and metal.

2. The microscale tissue cutting device of claim 1
wherein the vertically-oriented blades are serrated with one, two, or more serrations forming secondary vertical peaks.

3. The microscale tissue cutting device of claim 2
wherein the secondary vertical peaks have heights in the range 1-100 μm above the lowest height of the cutting edge of the blades.

4. The microscale tissue cutting device of claim 1
wherein the vertical peaks have an interior angle of 5-120 degrees in a vertical cross-sectional plane parallel to the blade.

5. The microscale tissue cutting device of claim 2
wherein the secondary vertical peaks have an interior angle of 5-120 degrees in a vertical cross-sectional plane parallel to the blade.

6. The microscale tissue cutting device of claim 1
wherein the cutting edge of the vertically-oriented blades has a bevel angle in the range 5-90 degrees in a vertical cross-sectional plane perpendicular to the blade.

7. The microscale tissue cutting device of claim 1
wherein the cutting edge of the vertically-oriented blades has a tip radius of curvature in the range 1 nm-1 μm.

8. The microscale tissue cutting device of claim 1
wherein each of the identically shaped polygonal through holes has a shape selected from the group consisting of a square, a rectangle, or a hexagon.

9. The microscale tissue cutting device of claim 1
wherein the horizontal array of identically shaped polygonal through holes is a one-dimensional array.

10. The microscale tissue cutting device of claim 1
wherein the horizontal array of identically shaped polygonal through holes is a two-dimensional array.

11. The microscale tissue cutting device of claim 1
further comprising a coating of silicon carbide (SiC) on the vertically-oriented blades.
